(19) United States
(12) Patent Application Publication
(10) Pub. No.: US 2024/0120816 A1
(43) Pub. Date: Apr. 11, 2024

(54) RESIN MOLDED STACK WITH ROUGHENED END PLATE

(71) Applicant: Ford Global Technologies, LLC, Dearborn, MI (US)

(72) Inventors: Devan James Anderson, Taylor, MI (US); Singar Rathnam, Farmington Hills, MI (US)

(73) Assignee: Ford Global Technologies, LLC, Dearborn, MI (US)

(21) Appl. No.: 17/960,507

(22) Filed: Oct. 5, 2022

(51) Int. Cl. H02K 15/12; B29C 45/14; H02K 15/03

(52) U.S. Cl. CPC H02K 15/12; B29C 45/14467; H02K 15/03; B29C 2045/1486; B29L 2031/7498

(57) ABSTRACT

A rotor includes a plurality of rotor cores arranged in a vertical stack, an end plate having a specified roughness on a surface engaging the vertical stack, and a binder material bonding the end plate to the vertical stack of rotor cores. The specified roughness is configured to allow venting of air beyond the end plate and to prevent passage of resin beyond the end plate.

### FIELD

The present disclosure relates to assembly of a rotor for an electric converter, and more particularly to a rotor formed of multiple rotor cores.

### BACKGROUND

The statements in this section merely provide background information related to the present disclosure and may not constitute prior art.

Recent advancements in electric converters such as electric motors and/or generators relate not only to performance, but also to manufacturing, as the need for electric converters has increased in various industries including automotive. More particularly, in the automotive industry, electric motors can vary across different platforms since powertrain requirements of a small vehicle is different from that of a truck. For example, with respect to the rotor of the electric motor, the overall size of the rotor (e.g., diameter, height, etc.) to the type of magnets installed, can vary platform-to-platform. Such variations can result in complex rigid assembly lines that impede dynamic flexible configurations.

Furthermore, rotors are complex assemblies, typically having a plurality of rotor cores with a plurality of magnets disposed in pockets of the rotor cores. During assembly of the rotor, resin is introduced to the rotor cores and air is evacuated from the rotor cores. Air pockets in the resin may cause an incomplete assembly of the cores. A dedicated vent plate allows the air to evacuate, but such vent plates are difficult to manufacture and introduce additional steps in the assembly of the rotor.

These and other issues related to the assembly of a rotor for an electric converter are addressed by the present disclosure.

### SUMMARY

This section provides a general summary of the disclosure and is not a comprehensive disclosure of its full scope or all of its features.

A method for manufacturing a rotor includes attaching an end plate to a stack of rotor cores, the end plate having a specified roughness on a surface engaging the stack of rotor cores, applying resin into the stack of rotor cores, and bonding the end plate to the stack of rotor cores with the applied resin. The specified roughness is configured to allow venting of air beyond the end plate and to prevent passage of resin beyond the end plate.

In variations of the method, which may be implemented individually or in combination: the specified roughness has an Ra value of about 50 microns; the specified roughness is based on a viscosity of the resin; further including lathing the end plate to the specified roughness; the stack includes a plurality of channels, and applying the resin into the stack of rotor cores further includes flowing the resin into the plurality of channels; the resin flows axially and radially through the plurality of channels; each rotor core includes at least one of the plurality of channels; the end plate includes a first portion of the surface having the specified roughness and a second portion of the surface having a second specified roughness; further including venting the air beyond the end plate without an additional venting tool; further including pressurizing the resin to vent the air beyond the end plate.

In another form, a rotor includes a plurality of rotor cores arranged in a vertical stack, an end plate having a specified roughness on a surface engaging the vertical stack, and a binder material bonding the end plate to the vertical stack of rotor cores. The specified roughness is configured to allow venting of air beyond the end plate and to prevent passage of resin beyond the end plate.

In variations of the rotor, which may be implemented individually or in combination: the specified roughness has an Ra value of about 50 microns; the specified roughness is based on a viscosity of the resin injected into channels of the plurality of rotor cores; the stack includes a plurality of channels, and the resin is injected through the plurality of channels; each rotor core of the plurality of rotor cores includes at least one of the plurality of channels.

In another form, a rotor is formed according to a method including attaching an end plate to a stack of rotor cores, the end plate having a specified roughness on a surface engaging the stack of rotor cores, applying resin to the stack, and bonding the end plate to the stack with the applied resin,

In variations of the rotor, which may be implemented individually or in combination: the specified roughness is determined to allow venting of air beyond the end plate and to prevent passage of resin beyond the end plate; the specified roughness has an Ra value of about 50 microns; the method further includes lathing the end plate to the specified roughness; venting the air beyond the end plate without an additional venting tool; pressurizing the resin until the air is vented beyond the end plate.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an electric converter having a plurality of rotor cores according to the present disclosure;

FIG. 2 is an exploded view of the electric converter of FIG. 1 according to the present disclosure;

FIG. 3 is an exploded view of a rotor core and magnets according to the present disclosure;

FIG. 4 is a side cross-sectional view of the electric converter according to the present disclosure; and

FIG. 5 is a front view of an end plate of the electric converter according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

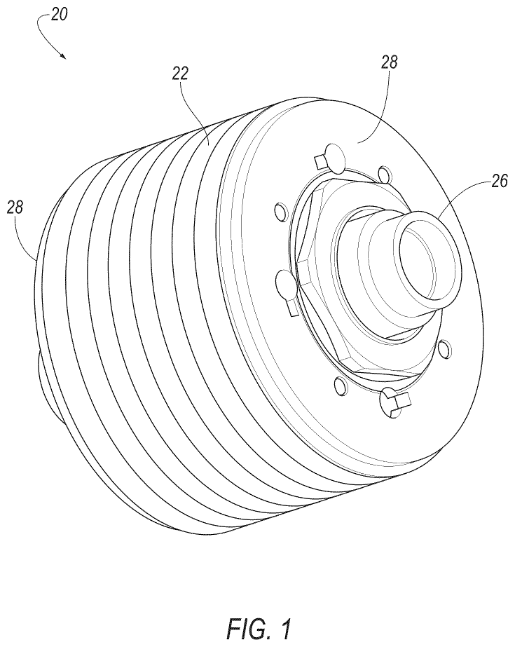

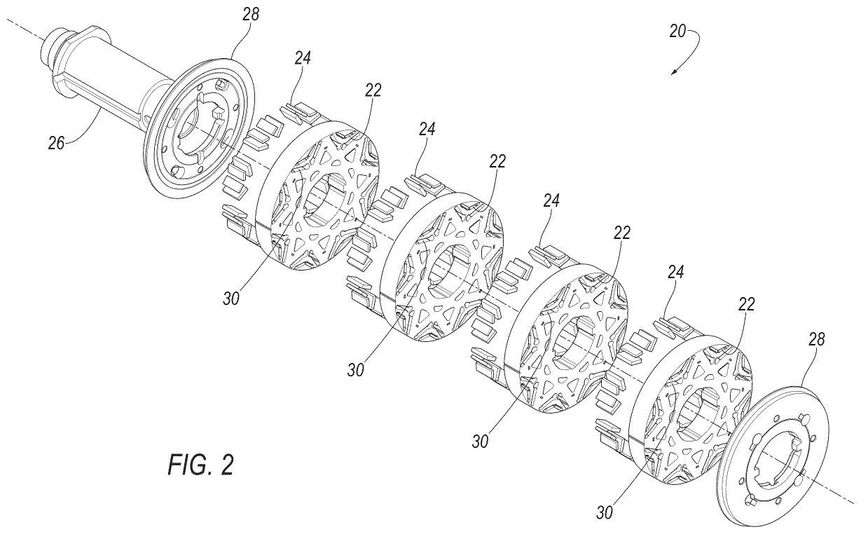

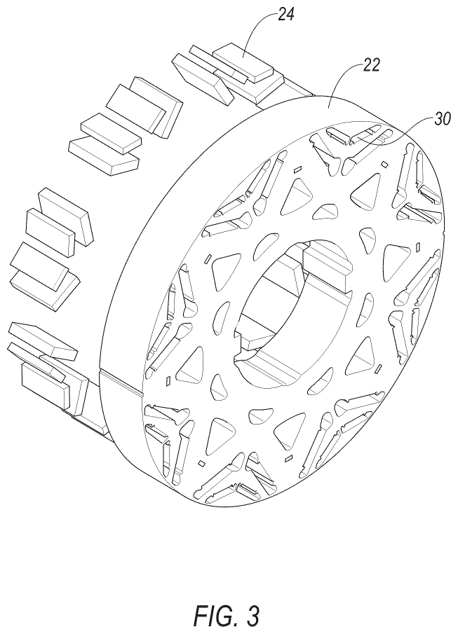

With reference to FIGS. 1-3, a rotor 20 of an electric motor/converter of a vehicle includes a plurality of rotor cores 22, a plurality of magnets 24 disposed in the rotor cores 22, a central shaft 26 onto which the rotor cores 22 are mounted, and a pair of end plates 28 attached to the plurality of rotor cores 22. The rotor cores 22 are stacked coaxially in a vertical direction, i.e., the rotor cores form a vertical “stack.” The end plates 28 secure the vertical stack of rotor cores 22 to the central shaft 26 during formation of the rotor 20. The magnets 24 are arranged to be disposed in respective channels 30 of the rotor cores 22, as shown in FIG. 3.

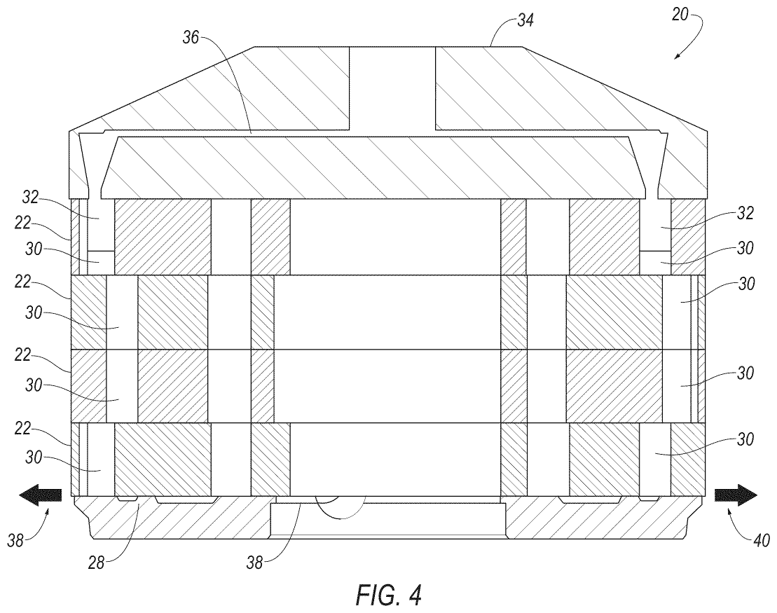

With reference to FIG. 4, the rotor cores 22 and the magnets 24 are joined with a binder material such as a resin 32 that is applied into each channel 30 to expel air in the channels 30. By expelling the air in the channels 30, the resin 32 adheres the magnets 24 to the rotor cores 22. In one form, the resin 32 is injected under high pressure by a runner plate 34 to force air out from the channels 30. The runner plate 34 includes injection channels 36 through which the resin 32 is injection from a resin supply (not shown) to the channels 30 of the rotor cores 22. In another form, the resin 32 is transferred under low pressure into the channels 30. The resin 32 is pressurized in the injection and transfer forms until the air is vented from the channels 30 of the stack of rotor cores 22. In yet another form, gravity moves the resin 32 through the channels 30.

In one form, the channels 30 of the rotor cores 22 are staggered vertically, i.e., the channels 30 of one of the rotor cores 22 may not completely align with the channels 28 of an adjacent rotor core 22. The staggered channels 28 allow the rotor cores 22 to be stacked with variability in their radial alignment while still allowing resin 26 to flow through the stack. The resin 26 flows axially down along the channels 28 and radially between the rotor cores 22, penetrating the space between the rotor cores 22 and expelling air therein.

The end plates 28, one of which is shown in FIG. 4, are bonded to the stack of rotor cores 22 with the binder material. The end plates 28 have a specified roughness on a respective surface 38 engaging the stack. The roughness is determined to allow venting of air 40 beyond the end plate 28 without an additional venting tool, such as a mandrel plate, and to prevent passage of resin 32 beyond the end plate. Air 40 in the stack may inhibit resin 32 penetration through the stack of rotor cores 22, reducing the bond strength of the fused stack. Instead of an additional venting tool that allows venting of air 40, the stack of rotor cores 22 are arranged between the end plates 28 such that the end plates 28 vent air 40 from the stack. To prevent loss of resin 32, the roughness of the surfaces captures resin 32 flowing along the end plates 28, trapping the resin 32 between the stack and the end plates 28. By venting the air 40 without the additional venting tool, fewer parts are used to form the rotor 20, and the rotor 20 is formed in fewer manufacturing steps.

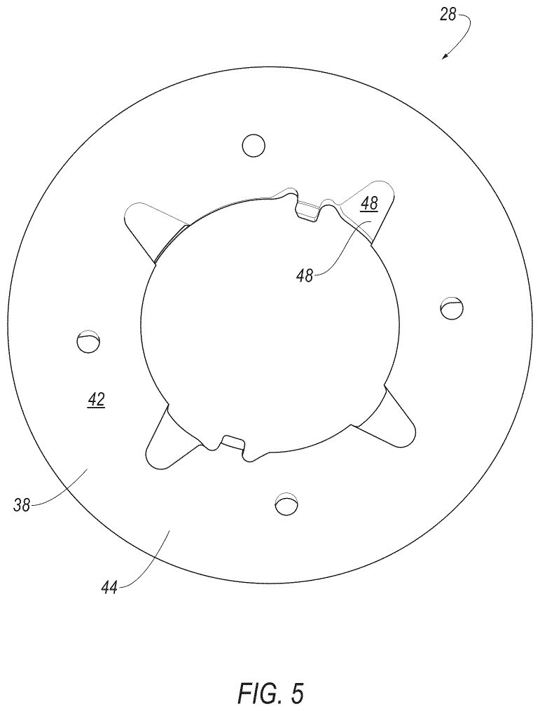

With reference to FIG. 5, the surface 38 of the end plate 28 that engages/abuts the stack of rotor cores 22 is shown. The inventors have discovered that a specific roughness of the surface 38 can be determined in order to inhibit resin 32 from flowing while at the same time allow passage of the air 40. Without being bound to any particular theory, this specified roughness forms deviations in the surface 38 small enough to block particles of the resin 32 and large enough to allow air to pass.

The surface 32 has a specified roughness 42 that is based on a viscosity or particle size of the resin, e.g., an Ra value of about 50 microns. In this context, an “Ra value” is the conventional roughness measurement indicating an average height of deviations (such as microscopic peaks and valleys) from a predetermined mean level. An Ra value of about 50 microns means that an average deviation from the mean level is about 50 microns, within a tolerance threshold of the machine forming the roughened surface. The roughness 42 can be determined in one form by empirically forming surfaces of specified roughnesses onto each of a plurality of test end plates and measuring amounts of resin and air that flow beyond each of the test end plates. In another form, the roughness 42 can be determined through computer aided engineering (CAE) software tools.

In one variation of the present disclosure, the end plate 28 includes a first portion 44 of the surface 38 having the specified roughness 42 and a second portion 46 of the surface having a second specified roughness 48. The first and second specified roughnesses 42, 48 are determined, e.g., to allow flow of resin 32 at different rates along the surface 38. In one form, the second specified roughness 48 is smoother than the first specified roughness 42, and the resin 32 flows more readily along the second portion of the surface 44. Accordingly, the smoother second specified roughness 48 allows the resin 32 to flow beyond the end plate 28, draining resin 32 from areas where resin 32 may not be intended to be applied. That is, the resin 32 accumulates on the first portion 44 to drive air 40 to the second portion 46, where the air 40 may more readily be expelled from the end plate 28. The accumulation of the resin 32 inhibits production of air pockets that may form from unexpelled air 40.

In one form, the end plate 28 is machined in a lathing machine. Machining the end plate 28 in a lathe provides circular symmetry of the end plate 28 during manufacturing. The end plate 28 is lathed to the specified roughness 42 with a polishing tool or an abrasive pad. The lathing machine applies the polishing tool/abrasive pad to form the microscopic peaks and valleys at the specified roughness 42. In one form, a polishing tool forms deviations in the surface 38 of the end plate 28 averaging about 50 microns, i.e., providing a surface 38 of the end plate 28 with an Ra value of about 50 microns. In another form the end plate 28 is manufactured by a different method, such as stamping, milling, or additive manufacturing.

By using the roughened end plate 28 to vent the air 40 from the stack of rotor cores 22, dedicated venting tools are not needed to manufacture the rotor 20. When the end plate 28 is formed by lathing, the lathing machine further applies the surface roughness 42 for the surface 38, forming the roughened end plate 28 with fewer manufacturing steps than another manufacturing method. Thus, the roughened end plate 28 improves manufacturing of the rotor 20 by reducing a total amount of parts and machines used to form the rotor 20.

While the specified roughnesses 42, 48 are achieved with machining in a lathe, it should be understood that other forms of roughening may be employed while remaining within the scope of the present disclosure. For example, the roughnesses 42, 48 may be achieved by shot peening, water jetting, CO2 blasting, laser cutting, or sanding.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing a rotor, the method comprising:
attaching an end plate to a stack of rotor cores, the end plate having a specified roughness on a surface engaging the stack of rotor cores;
applying resin into the stack of rotor cores; and
bonding the end plate to the stack of rotor cores with the applied resin,
wherein the specified roughness is configured to allow venting of air beyond the end plate and to prevent passage of resin beyond the end plate.

2. The method of claim 1, wherein the specified roughness has an Ra value of about 50 microns.

3. The method of claim 1, wherein the specified roughness is based on a viscosity of the resin.

4. The method of claim 1, further comprising lathing the end plate to the specified roughness.

5. The method of claim 1, wherein the stack includes a plurality of channels, and applying the resin into the stack of rotor cores further comprises flowing the resin into the plurality of channels.

6. The method of claim 5, the resin flows axially and radially through the plurality of channels.

7. The method of claim 5, wherein each rotor core includes at least one of the plurality of channels.

8. The method of claim 1, wherein the end plate includes a first portion of the surface having the specified roughness and a second portion of the surface having a second specified roughness.

9. The method of claim 1, further comprising venting the air beyond the end plate without an additional venting tool.

10. The method of claim 1, further comprising pressurizing the resin to vent the air beyond the end plate.

11. A rotor, comprising:
a plurality of rotor cores arranged in a vertical stack;
an end plate having a specified roughness on a surface engaging the vertical stack; and
a binder material bonding the end plate to the vertical stack of rotor cores,
wherein the specified roughness is configured to allow venting of air beyond the end plate and to prevent passage of resin beyond the end plate.

12. The rotor of claim 11, wherein the specified roughness has an Ra value of about 50 microns.

13. The rotor of claim 11, wherein the specified roughness is based on a viscosity of the resin injected into channels of the plurality of rotor cores.

14. The rotor of claim 11, wherein the stack includes a plurality of channels, and the resin is injected through the plurality of channels.

15. The rotor of claim 14, wherein each rotor core of the plurality of rotor cores includes at least one of the plurality of channels.

16. A rotor formed according to a method comprising:
attaching an end plate to a stack of rotor cores, the end plate having a specified roughness on a surface engaging the stack of rotor cores;
applying resin to the stack; and
bonding the end plate to the stack with the applied resin,
wherein the specified roughness is determined to allow venting of air beyond the end plate and to prevent passage of resin beyond the end plate.

17. The rotor of claim 16, wherein the specified roughness has an Ra value of about 50 microns.

18. The rotor of claim 16, wherein the method further comprises lathing the end plate to the specified roughness.

19. The rotor of claim 16, wherein the method further comprises venting the air beyond the end plate without an additional venting tool.

20. The rotor of claim 16, wherein the method further comprises pressurizing the resin until the air is vented beyond the end plate.
